(19) United States
(12) Patent Application Publication
(10) Pub. No.: US 2017/0220726 A1
(43) Pub. Date: Aug. 3, 2017

(54) METHOD AND SYSTEM FOR PERFORMING A DESIGN SPACE EXPLORATION OF A CIRCUIT

(71) Applicant: Samarth Sandeep Modi, Vadodara (IN)

(72) Inventor: Samarth Sandeep Modi, Vadodara (IN)

(21) Appl. No.: 15/010,814

(22) Filed: Jan. 29, 2016

(51) Int. Cl. G06F 17/50

(52) U.S. Cl. CPC G06F 17/5081; G06F 17/5009

(57) ABSTRACT

A method and system for performing a design space exploration of a circuit is disclosed. The method comprises receiving a design problem associated with a circuit topology and one or more design parameters of a circuit. The method further comprises segregating the design problem into two or more sub-design problems. The design problem is segregated to provide a solution for each sub-design problem through a design space exploration. The method further comprises representing the sub-design-problem in a hierarchal directional graph. The hierarchal directional graph comprises one or more nodes. The method further comprises recording values from each node in the hierarchal directional graph. The method further comprises performing the design space exploration, iteratively, based on the values recorded to obtain an optimal design parameters for the circuit.

### FIELD OF THE INVENTION

The present invention relates to a field of design space exploration, and more specifically to the field of recording information during the design space exploration and automating the design space exploration based on the information recorded.

### BACKGROUND

Analogue and mixed signal circuits form an integral part of Integrated Chips (IC). Efficiency of the analogue and mixed signal circuits determine speed, power consumption and efficiency of the ICs. Performance of the analogue and mixed signal circuits are measured in terms of one or more performance parameters. Examples of the performance parameters include, but is not limited to output power, gain, input resistance, slew rate, and area of the circuit.

Typically, the analogue and mixed signal circuit are implemented in accordance with a circuit design. The circuit design comprises one or more circuit components interconnected to each other in accordance with a circuit topology. In other words, the circuit topology is a representation of interconnection of the circuit components in the circuit design. Examples of the circuit topology includes, but is not limited to serial topology, parallel topology, pi topology, and star topology. Examples of the circuit components include, but are not limited to resistors, capacitors, inductors, transistors, and amplifiers.

Generally, the circuit topology is designed by considering one or more design parameters. The one or more design parameters comprise transistors defined via width, length, number of fingers of transistor, resistance, inductance, capacitance, leakage currents, temperature coefficients of the circuit components, the circuit topology, process technology parameters, and relationships of the one or more design parameters of the circuit components. In order to generate a plan for the circuit design, at first, a user selects the circuit topology. Further, the user tunes the one or more design parameters associated with the circuit components in the circuit topology. If there are any variation in the one or more design parameters, then there will be variation in the one or more performance parameters of the analogue and mixed signal circuit.

The analogue and mixed signal circuits suffer from multiple design problems. Typically, the design problems are associated with having lack of adequate values for the one or more performance parameters. To alleviate the design problems, the user has to optimize the one or more performance parameters. As discussed earlier, variation in the one or more design parameters cause variation in the one or more performance parameters of the analogue and mixed signal circuit. The one or more design parameters are varied to obtain optimal values that in turn optimizes the one or more performance parameters. Generally, the user varies the one or more design parameters via a design process.

Typically, the design process involves obtaining optimal values of the one or more design parameters and generating the optimal circuit design based on the optimal values. As known, the one or more design parameters and the one or more performance parameters are interdependent. However, prior art fails to predict ratio of the interdependency. In other words, variation in each design parameter causes unpredictable variations in the one or more performance parameters leading to ambiguity. As a result of the ambiguity, optimizing the one or more design parameters is a complex task and the design problems are inherently complex to solve. In order to solve the design problems, a user with high skill is to be employed in the design process. Employing the user is expensive and as a result, the design process becomes expensive.

Typically, the user solves the design problems by dividing a design problem into sub-design problems. Each sub-design-problem is associated with at least one design parameter in the one or more design parameters. The user solves the sub-design problem by using design space exploration iteratively. The user uses the design space exploration to identify optimal values of the one or more design parameters. In a typical system, the user begins the design space exploration by selecting the circuit topology. The circuit topology selected is hereafter referred to as a candidate circuit topology. As mentioned earlier, the circuit topology is the representation of interconnection of the circuit components in the circuit design. The one or more design parameters associated with the circuit components are tuned by the user. Generally, the designer chooses a set of design variable values and simulates circuit to check performance parameters. After tuning, the circuit design is referred to as a candidate circuit design. The candidate circuit design is simulated to obtain results and the results are recorded. If the results indicate that the candidate circuit design solves the sub-design problem, then the candidate circuit design is referred to as the optimal circuit design.

Typical systems for performing the design space exploration has multiple disadvantages. For example, the typical system records only final results obtained for the simulation. However, the typical system fails to record results of every iteration performed during the course of the simulation to obtain the final results. Further, the typical system fails to record the one or more design parameters used in every iteration of the simulation in the design space exploration.

In one example, a user generates simulation plans and a plurality of test benches to test circuit designs during the design space exploration. The simulation plans are strategies employed by the user to simulate the circuit designs. Further, the simulation plans comprises strategies to simulate the circuit designs for evaluating any circuit under different input stimulus and under various configuration. Generally, the design parameters at the time of simulation are fixed. A test bench is a software based platform used for testing the circuit designs for correctness and reliability. The typical system fails to record the simulation plans and the plurality of test benches. Further, the typical system fails to record history of steps taken by the user during the design space exploration.

Furthermore, the typical system fails to identify and record nature of interdependency between the one or more design parameters via the design space exploration. Furthermore, the typical systems fail to capture and generate proportionality equations describing the relationship between the one or more design parameters.

Further, the typical system fails to use the information captured from the design space exploration to automate the design space exploration. The typical system performs the design space exploration serially. However, the typical system fails to perform multiple design space explorations in parallel. Further, the typical system fails to provide suggestions to the user during the design space exploration based on the information recorded. Further, the typical system fails to visualize, compare, analyze, and retrieve the information recorded from the design space explorations.

### SUMMARY

The problems in the existing art are met by providing a method and system capable of recording information during a design space exploration and automating the design space exploration using the information recorded.

An example of a method for performing a design space exploration of a circuit is disclosed. The method comprises receiving, by a processor, a design problem associated with a circuit topology and one or more design parameters of a circuit. The method further comprises segregating, by the processor, the design problem into two or more sub-design problems. The design problem is segregated to provide a solution for each sub-design problem through a design space exploration. The method further comprises representing, by the processor, the sub-design-problem in a hierarchal directional graph. The hierarchal directional graph comprises one or more nodes. The method further comprises recording, by the processor, values from each node in the hierarchal directional graph. The method further comprises performing, by the processor, the design space exploration, iteratively, based on the values recorded to obtain an optimal design parameters for the circuit.

An example of a system for performing a design space exploration of a circuit comprises a processor and a memory coupled to the processor. The processor executes program instructions stored in the memory. The processor executes the program instructions stored in the memory to receive a design problem associated with a circuit topology and one or more design parameters of a circuit. The processor further executes the program instructions to segregate the design problem into two or more sub-design problems. The design problem is segregated to provide a solution for each sub-design problem through a design space exploration. Furthermore, the processor executes the program instructions to represent the sub-design-problem in a hierarchal directional graph. The hierarchal directional graph comprises one or more nodes. The processor further executes the program instructions to record values from each node in the hierarchal directional graph. The processor further executes the program instructions to perform the design space exploration based on the values recorded to obtain an optimal design parameters for the circuit.

An example of a non-transitory computer readable storage medium comprising program instructions which, when executed, are configured to perform a method for performing a design space exploration of a circuit comprises receiving a design problem associated with a circuit topology and one or more design parameters of a circuit. Further, the method comprises segregating, the design problem into two or more sub-design problems. The design problem is segregated to provide a solution for each sub-design problem through a design space exploration. Further, the method comprises representing the sub-design-problem in a hierarchal directional graph. The hierarchal directional graph comprises one or more nodes. Further, the method comprises recording values from each node in the hierarchal directional graph. Further, the method comprises performing, the design space exploration, iteratively, based on the values recorded to obtain an optimal design parameters for the circuit.

The features and advantages described in this summary and in the following detailed description are not all-inclusive, and particularly, many additional features and advantages will be apparent to one of ordinary skill in the relevant art in view of the drawings, specification, and claims hereof. Further, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF FIGURES

In the following drawings like reference numbers are used to refer to like elements. Although the following figures depict various examples, the invention is not limited to the examples depicted in the figures.

FIG. 1 is a block diagram of a system for performing design space exploration, in accordance with one embodiment of the present invention;

FIG. 2 is an exemplary illustration of a hierarchal directional graph, in accordance with another embodiment of the present invention;

FIG. 3 is an exemplary illustration of a leaf node, in accordance with yet another embodiment of the present invention;

FIG. 4 is a block diagram of an Exploration History Management Module (EHMM), in accordance with one embodiment of the present invention;

FIG. 5 is an example illustrating a circuit topology, in accordance with one embodiment of the present invention;

FIG. 6 is an hierarchal directional graph for the example illustrating the circuit topology, in accordance with one embodiment of the present invention; and

FIG. 7 is a flowchart of a method of performing design space exploration, in accordance with one embodiment of the present invention.

### DESCRIPTION

In the present disclosure, relational terms such as first and second, and the like, may be used to distinguish one entity from the other, without necessarily implying any actual relationship or order between such entities. The following detailed description is intended to provide example implementations to one of ordinary skill in the art, and is not intended to limit the invention to the explicit disclosure, as one or ordinary skill in the art will understand that variations can be substituted that are within the scope of the invention as described.

Embodiments of the present disclosure described herein disclose a method for performing design space exploration of a circuit. Further, the present disclosure discloses a system for recording information during the design space exploration. Further, the system visualizes the design space exploration as hierarchal directional graphs. Further, the system records simulation plans and test benches used by a user during the design space exploration. Further, the system calculates and records interdependencies between one or more design parameters in dependency tables. Further, the system records history of steps taken by the user during the design space exploration. Further, the system provides suggestions to the user during the design space exploration.

Furthermore, the system records an optimal circuit design generated using the design space exploration. Further, the system generates proportionality equations that represent the relationship between the one or more design parameters and the one or more performance parameters. The relationship generated between the design parameters and the performance parameters are updated during run time and the relationship is used in subsequent design variable generation.

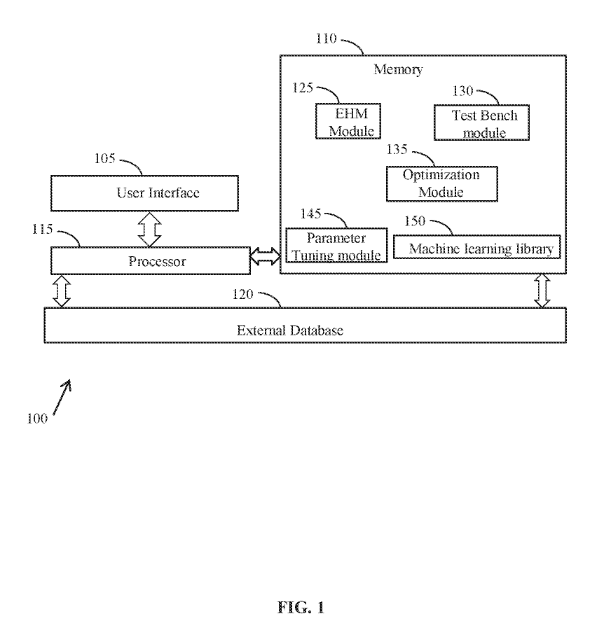

FIG. 1 is a block diagram of a system 100 for performing design space exploration in accordance with one embodiment of the present invention. In one embodiment of the present invention, a user uses the system 100 to perform the design space exploration for a circuit. The system 100 comprises a user interface 105, a memory 110, and a processor 115. The system 100 is communicatively connected to an external database 120. The user interface 105 comprises an input module and an output module (not shown). The input module enables a user to input data into the system 100. The data comprises media, instructions, numerical data, textual data, image based data and so on. Examples of the input module includes but is not limited to a keyboard, a touchscreen, a track pad, a track ball, a microphone, a camera, and a computer mouse. The output module presents the data to the user. Examples of the output module includes but is not limited to a display screen, a speaker, a printer, a projector and so on.

In one embodiment, the user interface 105 comprises a variety of software and hardware interfaces, for example, a web interface, a graphical user interface, and the like. The user interface 105 allows the system 100 to interact with the user. Further, the user interface 105 enables the system 100 to communicate with other computing devices, such as the external database 120 and web servers (not shown).

The memory 110 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 110 may further include algorithms, routines, program codes, program instructions, computer-readable instructions, data, and metadata.

The processor 115 comprises a microprocessor, a microcomputer, a microcontroller, a digital signal processor, a central processing unit, a state machine, and/or any devices that manipulate signals based on operational instructions. Further, the processor 115 is configured to fetch and execute computer-readable instructions stored in the memory 110. Examples of the processor 115 includes but is not limited to a dual core processor, an octa core processor, and a quad core processor.

The memory 110 further comprises modules among other things. The modules may include a sub-program, a sub-routine, program instructions that when executed performs certain functionalities. In one embodiment, the memory 110 comprises modules such as an Exploration History Management Module (EHMM) 125, a test bench module 130, an optimization module 135, a parameter tuning module 145, and a machine learning library 150.

The system 100 performs the design space exploration for a circuit. Examples of the circuit include, but is not limited to an analogue circuit, a digital circuit, a mixed signal circuit, and an analogue and mixed signal circuit. The circuit is implemented in accordance with a circuit design. Further, the circuit is characterized by performance. The performance of the circuit is dependent on one or more performance parameters defined for the circuit. Examples of the one or more performance parameters include but is not limited to gain, output power, input resistance, power efficiency and leakage current.

The circuit design is associated with one or more design parameters of the circuit. The one or more design parameters comprise transistor defined by width, length, number of fingers, resistance, inductance, capacitance, leakage currents, temperature coefficients of the circuit components, the circuit topology, process technology parameters, and the relationships of the circuit components. In order to design the circuit, at first, the user selects the circuit topology. Further, the user tunes the one or more design parameters associated with the circuit components in the circuit topology.

As discussed earlier, variation in the one or more design parameters cause variation in the one or more performance parameters of the circuit. Accordingly, varying the one or more design parameters will change the values of the one or more performance parameters. The values of the one or more design parameters are changed until optimal values are obtained for the one or more performance parameters. The circuit design having the optimal values corresponding to the one or more design parameters is an optimal circuit design. In order to obtain the optimal circuit design, the system 100 enables the user to perform the design space exploration on the circuit. To perform the design space exploration, the system 100 communicates with the external database 120.

The external database 120 is a server or a database residing outside of the system 100 and stores the data processed by the system 100. The system 100 may fetch the data stored from the external database 120 to execute the certain functionalities. The data stored in the external database 120 include but is not limited to circuit topologies, circuit designs, performance measurement algorithms, optimization algorithms, evaluation plans, test benches, simulation plans, look-up tables, and exploration history. The circuit topologies comprises a model illustrating two or more circuit components interconnected to each other. Examples of the circuit components include, but are not limited to inductors, resistors, capacitors, transistors, and amplifiers. Examples of the circuit topology includes, but is not limited to serial topology, parallel topology, pi topology, and star topology. The circuit designs comprise the two or more circuit components interconnected in accordance with a circuit topology. The circuit designs are associated with one or more design parameters and one or more performance parameters. Examples of the one or more design parameters include but is not limited to resistance, inductance, capacitance, leakage currents, temperature coefficients of the circuit components, the circuit topology, process technology parameters, and the relationships of the circuit components. Examples of the one or more performance parameters include but is not limited to gain, slew rate, output power, input resistance and leakage current. The performance measurement algorithms enable the system 100 to determine the one or more performance parameters for given values of the one or more design parameters. The look-up tables map the one or more design parameters to the one or more performance parameters.

The parameter tuning algorithms enable the system 100 to perform automated tuning of the one or more design parameters. The one or more design parameters are tuned to optimize the one or more performance parameters. The performance measurement algorithms enable the system 100 to calculate one or more performance parameters based on variation in the set of tunable parameters. The simulation plans are strategies employed by the user to simulate the circuit designs. The simulation plans comprises strategies to simulate the circuit designs at multiple process corners. Further, the simulation plans comprises strategies to simulate the circuit designs with multiple set of values of the one or more design parameters, and multiple circuit topologies. The test benches are software based platforms used for testing the circuit designs for correctness and reliability. Evaluation plans are strategies to evaluate performance of the circuit designs. The circuit topology, values of the one or more design parameters, the simulation plans, the test benches, the evaluation plans, results of the simulation and results of the evaluation used by the user during the design space exploration is collectively hereafter referred to as an exploration history.

To perform the design space exploration, at first, the system 100 receives input data regarding the design problem from the user. The system 100 receives the input data via the user interface 105. The input data may be provided in one of a text based command, a voice based command, and a gesture based command. In one example, the design problem is to achieve one or more design goals and design constraints. The one or more design goals and design constraints are set by the user.

After receiving the design problem, the system 100 segregates the design problem into two or more sub-design-problems. In one embodiment, the user defines how the design problem is segregated. A sub-design problem corresponds to at least one design parameter that needs to be optimized. The system 100 segregates the design problem to provide a solution for each sub-design-problem through the design space exploration. In other words, the design problem is solved by solving each sub-design-problem via the design space exploration. In another embodiment of the present invention, the design problem is solved by the design space exploration. The design problem and the two or more sub-design-problems associated with the design problem is collectively referred to as a macro-level exploration plan.

In one embodiment, the system 100 represents the macro-level exploration plan as a hierarchal directional graph. The hierarchal directional graph is referred to as an exploration guide. In another embodiment, the user creates the hierarchal directional graph using the user interface 105. The user creates the hierarchal directional graph by inputting a program code into the system 100. In one example, the user may input the program code in a programming language such as Python, C++, ruby, and C. The hierarchal directional graph comprises one or more nodes.

A node in the hierarchal directional graph represents a sub-design problem. In other words, a node comprises information associated with the sub-design problem. In one embodiment, the node is further partitioned into one or more sub-nodes. Each sub-node represents a partition of the sub-design-problem. The one or more nodes comprise leaf nodes and non-leaf nodes. The leaf nodes comprises a problem setup for the design space exploration required to solve the sub-design problem. Further, the leaf node comprises a list of the one or more design parameters.

In one embodiment of the present invention, the design space exploration comprises tuning the one or more design parameters. It is noted that tuning the one or more design parameters comprises varying values of the one or more design parameters in accordance with a resolution for tuning and a dynamic range for tuning. The resolution for tuning is a smallest possible difference that might occur in the one or more design parameters as a result of tuning. The dynamic range is difference between the greatest possible value of the one or more design parameters and the least possible value of the one or more design parameters. The leaf node comprises information pertaining to the resolution of tuning, and the dynamic range of the one or more design parameters. Examples of the leaf node include but is not limited to a parameter tuning node, a processing node, an activity node and a control node.

The system 100 uses the parameter tuning node to tune the one or more design parameters to optimize the one or more design parameters. After tuning, the system 100 selects another node in the hierarchal directional graph. The processing node enables the system 100 to select another node in the hierarchal directional graph during the design space exploration. The system 100 may start, stop and pause the design space exploration. The system 100 uses the control node to start, stop, and pause the design space exploration. It is known to a person skilled in the art that the one or more performance parameters of the circuit are dependent on one or more process technology parameters. The system 100 uses the activity node to gauge the process technology parameters of the circuit. Further, the system 100 uses the activity node to determine interdependency between the one or more design parameters and the one or more performance parameters.

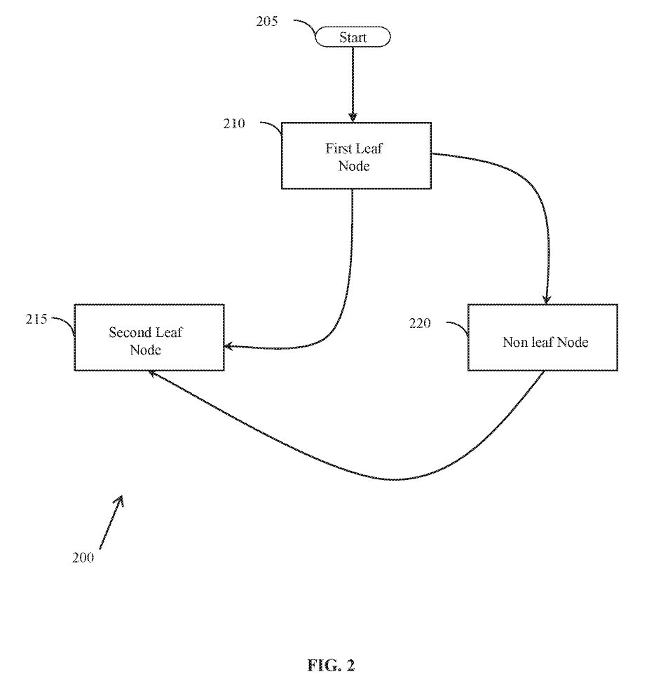

The hierarchal directional graph is explained in detail with reference to FIG. 2. Referring to FIG. 2, a hierarchal directional graph 200 comprises a start node 205, a first leaf node 210, a second leaf node 215 and a non-leaf node 220. The hierarchal directional graph 200 represents a design problem. Each of the first leaf node 210, the second leaf node 215 and the non-leaf node 220 represent one or more sub-design problems. The hierarchal directional graph 200 begins at the start node 205. The leaf nodes (210 and 215) carry information pertaining to the design problem, the one or more sub-design-problems, and the one or more design parameters. Further, the leaf nodes (210 and 215) comprises a list of design parameters required to be tuned. The leaf nodes (210 and 215) further comprises information pertaining to resolution for tuning, and dynamic range for tuning the one or more design parameters.

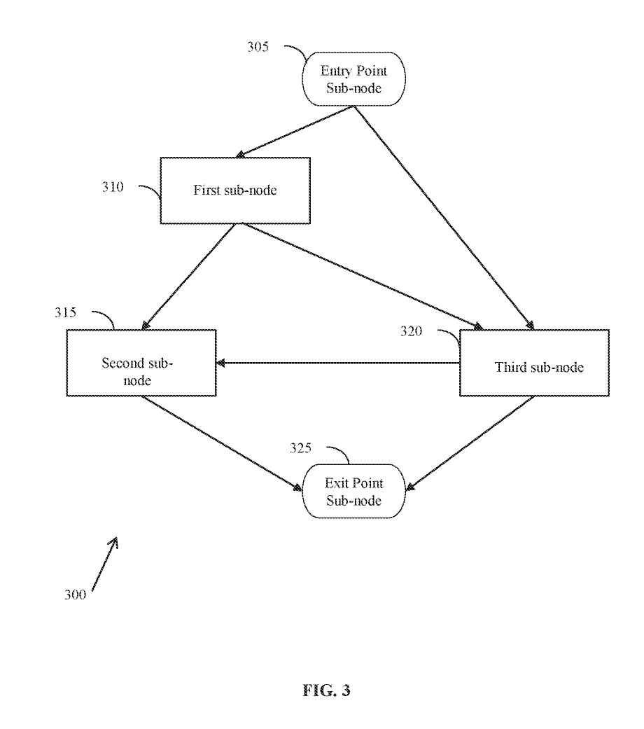

The non-leaf node 220 comprises one or more sub-nodes. As discussed earlier, each sub-node represents partitions of the one or more sub-design-problems. The one or more sub-nodes comprises an entry point sub-node and an exit point sub-node. The non-leaf node 220 is explained in detail with reference to FIG. 3. Referring to FIG. 3, a non-leaf node 300 comprises an entry point sub-node 305, a first sub-node 310, a second sub-node 315, a third sub-node 320, and an exit point sub-node 325. The entry point sub-node 305 is indicative of beginning of the design space exploration corresponding to the non-leaf node 300. The exit point sub-node 325 is indicative of end of the design space exploration for the sub-design-problem corresponding to the non-leaf node. The entry point sub-node 305 helps in deciding which node to proceed based on conditions e.g. if power is less than a pre-defined limit, then the process goes to the first sub-node 310 else the process goes to the second sub-node 315. Similarly, the exit point sub-node 325 decides which is the next node based on design space exploration results.

Referring to FIG. 1, the system 100 performs the design space exploration in accordance with the hierarchal directional graph. As known, the hierarchal directional graph represents the design problem and each node in the hierarchal directional graph represents the sub-design-problems. To solve the design problem, the system 100 solves sub-design-problems represented by each node progressively. In one example, the system 100 selects a node representing a sub-design-problem. The system 100 performs the design space exploration to solve the sub-design-problem. After performing the design space exploration, the system 100 selects another node in the hierarchal directional graph. The node selected represents another sub-design-problem. The system solves the sub-design-problem via the design space exploration. The system selects yet another node based on the design space exploration of the previous node selected. Similarly, the system 100 performs the design space exploration for each node in the hierarchal directional graph. In one embodiment of the present invention, the system 100 selects two or more nodes simultaneously. The system 100 performs the design space exploration required to solve the two or more nodes concurrently.

The system 100 selects a first node in the hierarchal directional graph to perform the design space exploration. The first node comprises information pertaining to a sub-design-problem. To solve the sub-design-problem, at first, the system 100 retrieves the circuit topology from the external database 120. As presented above, the circuit topology is also referred as the candidate circuit topology. In one embodiment of the present invention, the user inputs the candidate circuit topology via the user interface 105. The candidate circuit topology, i.e., connections of the circuit components, is provided as an input to define conditions for the entry and exit points. In one embodiment, the input for the candidate circuit topology may be provided using an image file, and a natural language description. If the user inputs the candidate circuit topology, then the system 100 stores the candidate circuit topology in the external data base 120 and the machine learning library 150. In another embodiment of the present invention, the system 100 retrieves a list of circuit topologies from the external database 120 and the machine learning library 150. The candidate circuit topology comprises a model illustrating the circuit components interconnected to each other. As known, the circuit components are associated with the one or more design parameters. The system 100 enables the user to solve the sub-design-problem by varying the one or more design problems to optimize the one or more performance parameters. The one or more design parameters comprises a set of tunable design parameters. Further, the performance parameters are provided with constraints or specification. The constraints or specification are provided to obtain optimum end results or objectives. For example, consider an amplifier design that needs to be optimized for lowest power. At the time of optimizing the amplifier design, the system 100 should meet certain speed requirements and noise requirements.

Further, the first node comprises information regarding the set of tunable design parameters. If the first node is a parameter tuning node, the system 100 selects the set of tunable design parameters from the one or more design parameters. In one embodiment of the present invention, the user selects the set of tunable design parameters.

Further, the system 100 tunes the set of tunable design parameters. Specifically, the system 100 employs the parameter tuning module 145 and the optimization module 135 to tune the set of tunable design parameters. In order to tune the set of tunable design parameters, the parameter tuning module 145 retrieves dynamic range and resolution of the set of tunable design parameters from the parameter tuning node. In one embodiment, the system 100 allows the user to define a weightage for user defined ranges of the set of tunable design parameters. The user defines the weightage during the design space exploration. The user defines the weightage on the user interface 105. The weightage is defined in at least one of numerals and textual data. In an exemplary illustration of the working of the present invention, the tunable design parameter is a transistor length. Dynamic range of the transistor length is between 0.1 micrometer and 1 micrometer. The user assigns weightage for a user defined range of the transistor length e.g., 0.1 micrometer to 0.2 micrometer. For the above example, the 50% weightage is assigned for 0.1 micrometer to 0.2 micrometer of the transistor length and 50% weightage is assigned to 0.2 to 1 micrometer of the transistor length. The parameter tuning module 145 tunes the transistor length to a first value between 0.1 micrometer to 0.2 micrometer for greater number of instances in comparison with a second value between 0.1 micrometer and 1 micrometer. For the above example, the parameter tuning module 145 generates 2000 values of design parameters. On an average, 1000 values are provided between 0.1 to 0.2 micrometer of the transistor length and 1000 values are provided between 0.2 to 1 micrometers of the transistor length.

In one embodiment of the present invention, the parameter tuning module 145 comprises parameter tuning algorithms. The system 100 uses the parameter tuning algorithms to perform automated tuning of the set of tunable design parameters. As known, the set of tunable design parameters are tuned to optimize the one or more performance parameters under given constraints or specification. For example, consider there are design parameters, P1 and P2. For each design parameters, P1 and P2, different values are generated. Subsequently, the parameter tuning module 145 calls Spice/Circuit Simulators to measure the performance parameters. After measuring the performance parameters, the system 100 provides the results. The results obtained are analyzed to optimize next optimum values (design variables). The next optimum values are analyzed by the optimization module 135.

The optimization module 135 analyzes the results to provide the next set of design variables. In order to provide the next set of design variables, the optimization module 135 uses algorithms including, but is not limited to equation solver algorithms, gradient descent algorithms, stochastic search algorithms, and evolutionary algorithms. The equation solver algorithms perform automated tuning using mathematical equations. In one embodiment, the user provides the mathematical equations as an input via the user interface 105. In another embodiment of the present invention, the system 100 retrieves the mathematical equations from the external database 120. The gradient descent algorithm tunes the set of tunable design parameters in steps. Each step is proportional to a gradient in the one or more performance parameters. The gradient is rate of change of the one or more performance parameters with respect to variation in the one or more design parameters. The stochastic search algorithms use randomized decisions to tune the set of tunable design parameters. The evolutionary algorithms uses parallel processing and artificial intelligence to optimize the one or more performance parameters.

In one embodiment, the optimization module 135 provides the system 100 with the look-up table. The look-up table comprises one or more design parameters mapped to the one or more performance parameters. The look-up table is mapped based on interdependency, proportionality, and inequalities between the one or more design parameters and the one or more performance parameters. In another embodiment of the present invention, the user provides the look-up table as an input to the system 100 via the user interface 105. In another embodiment of the present invention, the look-up table is stored in the memory 110. In one example, the look-up table is referred to as a dependency table. The optimization module 135 uses the dependency table to generate the new or next set of design variables. In other words, the optimization module 135 uses the look-up table to estimate the values of the set of tunable design parameters to derive a solution to the sub-design-problem.

Subsequently, the system 100 employs the parameter tuning module 145 to tune the set of tunable design parameters. After tuning, the system 100 records values of the set of tunable parameters and the one or more performance parameters in the external database 120. Further, the system 100 records values of the set of tunable parameters and the one or more performance parameters in the machine learning library 150.

In one embodiment, the system 100 receives an input from the user to adjust or generate the set of tunable design parameters. The input may indicate an instruction. For example, the user may give an instruction to adjust the values of the tunable set of design parameters. Further, the input comprises a comment from the user. The comment includes a mention of a reason for adjusting the values of the tunable set of design parameters. Further, the system 100 records the input in the external database 120. Examples of the input include, but is not limited to a text based input, a voice based input, and a gesture based input. After receiving the input from the user, the system 100 employs the parameter tuning module 145 to generate the set of tunable design parameters. The input provided by the user may be used with the design space exploration in synergistic fashion to obtain the optimum design parameters. In other words, the user may provide the input during the design space exploration. The input is considered to improve the results.

After generating the set of tunable design parameters, the system 100 enables the user to simulate the candidate circuit design. In one example, the system 100 employs the optimization module 135 to simulate the candidate circuit design. The user simulates the candidate circuit design to determine the one or more performance parameters corresponding to the set of tunable design parameters. To simulate the candidate circuit design, at first, the system 100 retrieves simulation plans and test benches from the external database 120. The simulation plans are strategies employed by the user to simulate the circuit designs. Further, the simulation plans comprise strategies to simulate the circuit designs with one set of design parameters and tested under one or more input stimulus and under different process corners and under different configuration, and multiple circuit topologies. A test bench is a software based platform used for testing the circuit designs for correctness and reliability. The system 100 stores the test benches in the test bench module 130. In one embodiment of the present invention, the user designs the simulation plans and test benches. If the user designs the simulation plans and the test benches, then the system 100 stores the simulation plans and the test benches in the external database 120 and the machine learning library 150. In another embodiment of the present invention, the user selects the simulation plans and the test benches from the external database 120.

The system 100 uses the simulation plans to perform simulation on the candidate circuit. The system 100 performs the simulation to generate simulation results. Further, the system 100 uses the simulation results to determine interdependency between the set of tunable design parameters and the one or more performance parameters. After simulation, if the results are found to be as per the objectives set or defined, then the solution is taken for consideration. If the results are not found to be as per the objectives, then the design parameters are changed using the optimization module 135. After changing the design parameters, the simulation is performed once again by the system 100 to check the solution with respect to the objectives. Further, the parameter tuning module 145 helps (using the algorithms) in tuning the values of the design parameters to obtain the desired result.

In one embodiment of the present invention, the system 100 records information pertaining to the interdependency in look-up tables in the optimization module 135. In another embodiment of the present invention, the system 100 alters the performance measurement algorithms in the optimization module 135 based on the interdependency between the set of tunable design parameters and the one or more performance parameters. Further, the system 100 alters behavior of the optimization algorithm with the interdependency in the look-up tables. Furthermore, the system 100 determines and records proportionality equations and inequalities between the one or more design parameters and the one or more performance parameters. To perform the simulation, external simulation software is used such as SPICE™ and Simulink™. Further, the system 100 tests the candidate circuit design with the test benches to generate test results. The system 100 records the simulation plans, the test benches, test results and simulation results in the external database 120. After obtaining the results of the simulation, the new interdependency between the set of tunable design parameters and the one or more performance parameters are used for subsequent iterations of the design space exploration. The design space exploration is continued for subsequent iteration until a feasible solution with respect to the objectives are met.

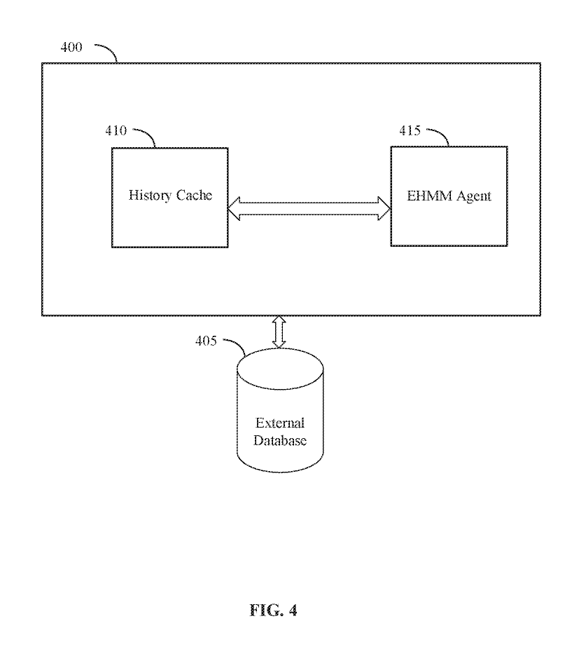

Further, the system 100 retrieves evaluation plans from the external database 120. Evaluation plans are strategies to evaluate performance of the candidate circuit design. In one embodiment of the present invention, the user designs the evaluation plans. If the user designs the evaluation plans, then the system 100 stores the evaluation plans in the external database 120 and the machine learning library 150. The system 100 evaluates the candidate circuit design in accordance with the evaluation plans. The system 100 uses the test benches to evaluate the candidate circuit design. Further, system 100 transmits the candidate circuit topology, values of the set of tunable design parameters, the simulation plans, the test benches, the evaluation plans, results of the simulation and results of the evaluation to the EHMM 125. As discussed earlier, the user inputs a comment providing a reason for adjusting the values of the tunable set of design parameters. After receiving the input, the system 100 transmits the comment to the EHMM 170. It is to be noted that the candidate circuit topology, values of the set of tunable design parameters, the simulation plans, the test benches, the evaluation plans, results of the simulation and results of the evaluation are collectively hereafter referred to as an exploration history. The EHVM 170 is explained in detail with reference to FIG. 4.

Referring to FIG. 4, an EHMM 400 comprises a history cache 410, and an EHMM agent 415. The EHMM agent 415 analyzes the results of the simulation and evaluation of circuits. Further, the EHMM agent 415 compares the exploration history with data present in the external database 405. If the results of the simulation and the evaluation match with the data present in the external database 405, then the EHMM 415 aborts the evaluations and simulations being performed. Further, the EHMM agent 415 identifies useful information in the exploration history received. The EHMM agent 415 stores the exploration history in an external database 405 and the history cache 410. Further, the EHMM agent 415 stores the exploration history as a sequence of steps. The EHMM 415 enables the user to access the external data base 405 and the history cache 410 via a user interface. In other words, the EHMM agent 415 enables user to view, analyze, retrieve, and compare information pertaining to the exploration history as a sequence of steps.

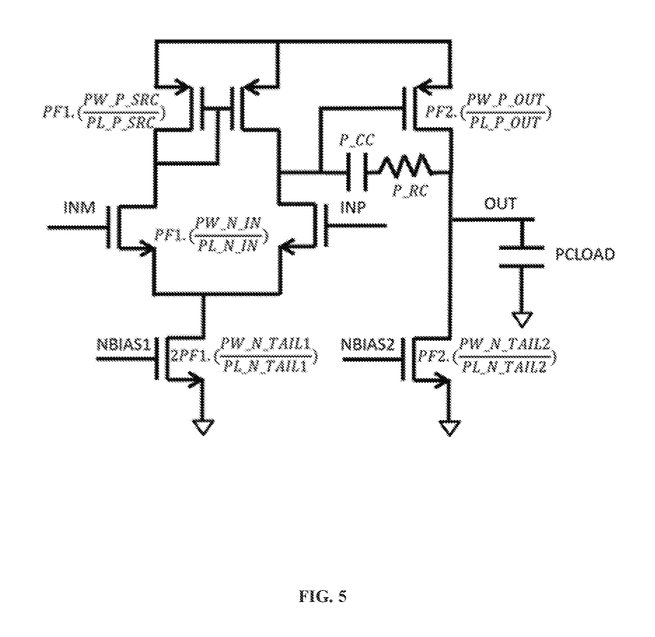

The working of the system 100 is explained using an example of a circuit topology shown in FIG. 5. Referring to FIG. 5, a circuit topology of a miller amplifier (millerAmp) is shown. The circuit comprises eight tunable variables. The eight tunable variables include PL_N_IN, PL_P_SRC, PL_P_OUT, PL_N_TAIL2, PF1, PF2, P_CC and P_RC. As discussed above, specification or constraints are defined for the circuit topology. For the above example, the constraints or specifications are defined in 65 nM technology. Consider the constraints define are as follows.

Constraint: INTEG_OP_NOISE<=150U [V]

### Constraint: UGB>=150MEG [Hz]

Constraint: PHASE_MARGIN>=60 [deg]
Constraint: DC_GAIN>=45 [dB]

The constraints presented above are used for exemplary purpose and it should be understood that the system 100 is capable of performing design space exploration with different limits, for example DC gain>=50 dB and the hierarchical graph helps in achieving different specifications/constraints. For the above circuit topology, objective or goals are specified for optimization. For example, the goals for optimizing the circuit topology may include—Meet the specifications with minimum power and meet the specifications with minimum Area. After specifying the goals, the specifications and design problems are captured. In one implementation, the design problem is captured in a configuration file. The configuration file may also be termed as a designer configuration file.

For the example used above, the design problem captured in the configuration file is as follows:

number of variables=8
number of objectives=2
number of constraints=5

Further, design variables associated with the design problem are considered. The design variables captured are as follows:

# designVariable: varName minValue maxValue resolution [unit]
designVariable: PL_N_IN 0.1u 1.0u 0.01u [uM]
designVariable: PL_P_SRC 0.1u 1.0u 0.01u [uM]
designVariable: PL_P_OUT 0.1u 1.0u 0.01u [uM]
designVariable: PL_N_TAIL2 0.1u 1.0u 0.01u [uM]
designVariable: PF1 1 500 1 [ ]
designVariable: PF2 1 500 1 [ ]
designVariable: P_CC 0.1P 20P 0.1P [F]
designVariable: P_RC 1 3000 1 [ ]

Similarly, the objectives of the design problem are captured, as

#objective: objName direction [unit]
objective: PF min [ ]
objective: AREA min [ ]

Further, the constraints for the design problem are captured, as

#constraint: conName equalitySign targetValue [unit]
constraint: INTEG_OP_NOISE<=150U [V]
constraint: UGB>=150MEG [Hz]
constraint: PHASE_MARGIN>=60 [deg]
constraint: DC_GAIN>=45 [dB]

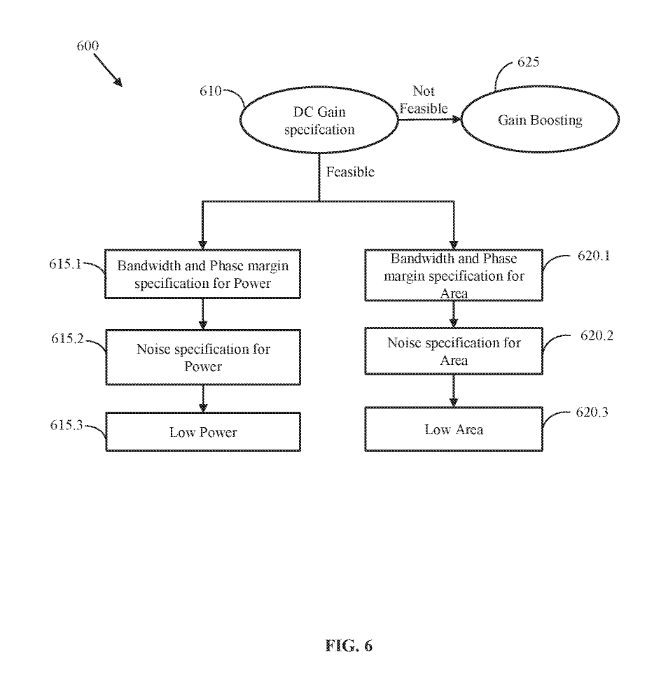

After capturing the design problem in the configuration file, the design problem of the circuit is segregated into sub-design problems. The system 100 segregates the design problem to provide a solution for each sub-design-problem through the design space exploration by representing in a hierarchal directional graph as shown in FIG. 6. Referring to FIG. 6, a hierarchical graph 600 showing a design problem and sub-design problems is shown, in accordance with one exemplary embodiment. At first, the specification for the design problem of DC gain may be presented as a node 610. In order to solve the design problem, the design problem may be segregated into sub-design problems. Further, the specification for the sub-design problems may be captured as sub-nodes in the hierarchical graph. For the above example, the specification for the sub-design problem of power optimization may be captured in the sub-nodes 615.1, 615.2, and 615.3 in the hierarchical graph 600. Similarly, the specification for the sub-design problem of area optimization may be captured in the sub-nodes 620.1, 620.2, and 620.3 in the hierarchical graph 600.

To solve the sub-design problem, the system 100 retrieves connections of the circuit components and values of the design parameters. At first, 4 variables out of 8 variables are used for optimization as per the configuration file listed below, and the values of other 4 variables are fixed to a predetermined or minimum value provided in the configuration file of the complete problem. In order to provide solution for meeting DC gain specification in the above example, the system 100 uses the configuration file as the following.

number of variables=4
number of objectives=1
number of constraints=1
# designVariable: varName minValue maxValue resolution [unit]
designVariable: PL_N_TAIL2 0.1u 1.0u 0.01u [uM]
designVariable: PL_P_SRC 0.1u 1.0u 0.01u [uM]
designVariable: PL_P_OUT 0.1u 1.0u 0.01u [uM]
designVariable: PL_N_IN 0.1u 1.0u 0.01u [uM]
#objective
objective: AREA min
constraint: DC_GAIN>=46

In the above example, the system 100 reduces number of tunable variables and reduces number of specifications with 1 dB margin—45+1=46 dB. As can be seen from the example, margin obtained is 1 dB. It should be understood that the margin may be adjusted to have different values other than 1 dB. Similarly in other sssub problems (615.1, 615.2, 615.3, 620.1, 620.2, and 620.3) margins are added in the constraint, these are also for only illustration purpose and these margins can be modified at the run time by the user of the system. Based on the above design space exploration is run and feasibility of the solution is checked at every iteration. If anytime the solution found is feasible, then design space exploration is stopped for sub node 610 and values of design variables, PL_N_IN, PL_P_SRC, PL_P_OUT, PL_N_TAIL2 in the feasible solution are used in other nodes and are referred as solution of node 610 in following description. However, if design space exploration does not yield a feasible solution, then a gain boosting topology is used (625) to obtain miller amp design with given specification. Gain boosting topology is not explained in the present example.

After finding the feasible solution in 610, the system 100 runs design space exploration for power optimization and area optimization. The system 100 may run the design space exploration for the power optimization and area optimization either independently or simultaneously (i.e. node 615.1, and 620.1).

The design space explorations are run for bandwidth and phase margin specification. For power optimization (615.1), a designer power configuration file with 3 variables, 1 objective and 2 constraints are used and are as follows. Further, design variable values for PL_N_IN, PL_P_SRC, PL_P_OUT and PL_N_TAIL2 are fixed to the values of result of node 610.

number of variables=3
number of objectives=1
number of constraints=2
# designVariable: varName minValue maxValue resolution [unit]
designVariable: PF1 1 500 1 [ ]
designVariable: PF2 1 500 1 [ ]
designVariable: P_CC 0.1P 20P 0.1P [F]
#objective
objective: PF min
constraint: UGB>=160MEG
constraint: PHASE_MARGIN>=61

After obtaining the solution, if the solution is found to be feasible 610, then the system 100 stops design space exploration for node 615.1. The system 100 uses the solution (i.e. values of design variables PF1, PF2 and P_CC) to fix initial values of design parameters of 615.2.

The design space exploration is run for bandwidth and phase margin specification. For area optimization (620.1), a designer power configuration file with 3 variables, 1 objective and 2 constraints is used and is as follows. Further, design variable values for PL_N_IN, PL_P_SRC, PL_P_OUT and PL_N_TAIL2 is fixed to the values of result of node 610.

number of variables=3
number of objectives=1
number of constraints=2
# designVariable: varName minValue maxValue resolution [unit]
designVariable: PF1 1 500 1
designVariable: PF2 1 500 1
designVariable: P_CC 0.1P 20P 0.1P [F]
#objective
objective: AREA min
constraint: UGB>=160MEG
constraint: PHASE_MARGIN>=61

After obtaining the solutions, if the solution is found to be feasible 610, then the system 100 stops design space exploration for node 620.1. The system 100 uses the solution (i.e. values of design variables PF1, PF2 and P_CC) to fix initial values of design parameters of 620.2.

Once Node 615.1 is completed, solutions from node 610 (Values PL_N_IN, PL_P_SRC, PL_P_OUT, PL_N_TAIL2) and 615.1 (values of PF1, PF2, P_CC) are considered as an initial solution for node 615.2 and also range of variables is fixed around initial values of node 615.2. Node 615.2 is considered to perform design space exploration for meeting noise specification.

number of variables=7
number of objectives=1
number of constraints=3
# designVariable: varName minValue maxValue resolution [unit]
designVariable: PL_N_TAIL2
designVariable: PL_P_SRC 0.1u 0.15u 0.01u [uM]
designVariable: PL_P_OUT 0.1u 0.15u 0.01u [uM]
designVariable: PL_N_IN 0.1u 0.12u 0.01u [uM]
designVariable: PF1 4 12 1 [ ]
designVariable: PF2 14 42 1 [ ]
designVariable: P_CC 0.3P 0.9P 0.01P [F]
#objective
objective: PF min
constraint: INTEG_OP_NOISE<=150U
constraint: UGB>=160MEG
constraint: PHASE_MARGIN>=60

Initial solution for 615.2 (DC gain optimization) comprising range of variables is restricted around the values of the initial solution as explained above. In one example, the range may be taken as 50% around the values of the initial solution obtained for DC gain optimization.

Similarly, the initial solution for 620.2 is obtained from 610 and 620.1. Node 620.2 is considered to perform design space exploration for meeting noise specification

number of variables=7
number of objectives=1
number of constraints=3
# designVariable: varName minValue maxValue resolution [unit]
designVariable: PL_N_TAIL2 0.18u 1.0u 0.01u [uM]
designVariable: PL_P_SRC 0.1u 0.15u 0.01u [uM]
designVariable: PL_P_OUT 0.1u 0.15u 0.01u [uM]
designVariable: PL_N_IN 0.1u 0.12u 0.01u [uM]
designVariable: PF1 3 12
designVariable: PF2 13 39
designVariable: P_CC 0.3P 0.9P 0.01P [F]
#objective
objective: AREA min
constraint: INTEG_OP_NOISE<=150U
constraint: UGB>=160MEG
constraint: PHASE_MARGIN>=60

Specifically, initial solution (DC gain optimization) comprising range of variables is restricted around the values of the initial solution obtained for DC gain optimization. In one example, the range may be taken as 50% around the values of the initial solution obtained for DC gain optimization. The initial solution for 615.2 is obtained from 610 and 615.1. Subsequently, node 615.2 performs the design space exploration.

In order to obtain an optimum solution having a low power with all the specification and all the variables (i.e. Node 615.3), the system 100 considers the solution obtained from node 615.2 and initial value of P_RC. The initial value of P_RC may be calculated as {1000*10/PF2}. It should be noted that the initial value of P_RC is considered for explanation purpose. However, the initial value of P_RC may include a pre-determined number. In one embodiment, the initial value of P_RC may be calculated at run time. It should be noted that the range of the variables are conservative as they are based on the values obtained during node 615.2. As presented, the system 100 considers the solution obtained from 615.2 and initial value of P_RC to obtain an optimum solution for low power. In one implementation, the EHMM module (for example, EHMM module 125) may store the values corresponding to the solution obtained and may use the values in subsequent iterations to obtain the optimum solution. For the above, the system 100 uses a configuration file combining all the configuration files (for power) used above to obtain the optimum solution.

The solution from 615.2 with seven variables and value of P_RC derived as explained earlier is used to set range of variables and are adjusted to obtain the optimum solution in 615.3. In one example, the range may be taken as 5% around the values of the initial solution obtained.

Similarly, in order to obtain an optimum solution having a low area, the system 100 considers the solution obtained for area (noise) optimization (with seven variables) and initial value of P_RC. The initial value of P_RC may be calculated as {1000*10/PF2}. It should be noted that the initial value of P_RC is considered for explanation purpose. However, the initial value of P_RC may include a pre-determined number. In one embodiment, the initial value of P_RC may be calculated at run time. It should be noted that the range of the variables are conservative as they are based on the values obtained during area (noise) optimization (with seven variables). As presented, the system 100 considers the solution obtained for area (noise) optimization (with seven variables) and initial value of P_RC to obtain an optimum solution for low area. For the above, the system 100 uses an area configuration file combining the configuration files (for area) used above to obtain the optimum solution.

The solution from 620.2 with seven variables and value of P_RC derived as explained above is used to set range of variables and are adjusted to obtain the optimum solution in 620.3. In one example, the range may be taken as 5% around the values of the initial solution obtained.

The above example is presented for exemplary purpose and should not be considered to limit the scope of the disclosure. Further, the variables and the ranges considered may vary depending upon the configuration or specification or constraints or goals or combination thereof. Any modifications to the goals or constraints or variables are considered to be within the scope of the present disclosure.

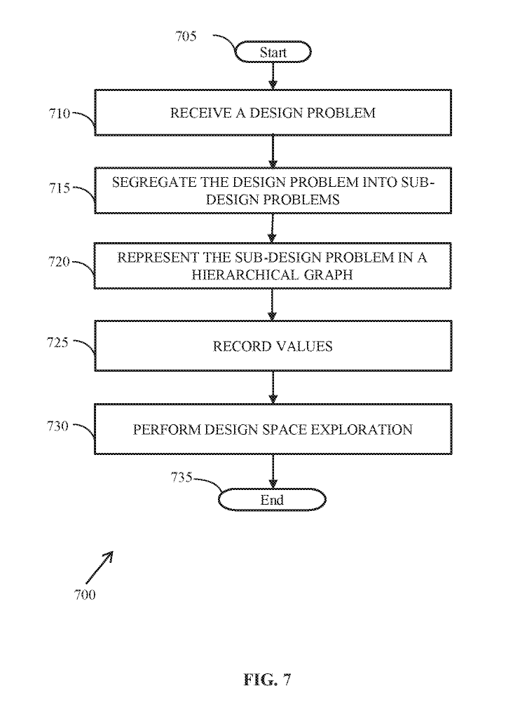

FIG. 7 is a flowchart of a method 700 of performing a design space exploration in accordance with one embodiment of the present invention. The method 700 may be described in the general context of computer executable instructions. The computer executable instructions comprise routines, programs, objects, components, data structures, procedures, modules, functions, etc., that perform particular functions. The order in which the method 700 is described and is not intended to be construed as a limitation, and any number of the described method blocks can be combined in any order to implement the method 700 or alternate methods. Additionally, individual blocks may be deleted from the method 700 without departing from the scope of the disclosure described herein.

The method 700 of performing the design space exploration begins at step 705. In one implementation, the method 700 is performed using the system 100 described above.

At step 710, a design problem associated with one or more design parameters of a circuit is received. The design problem is received by a processor from a user.

At step 715, the design problem is segregated into two or more sub-design problems. The design problem is segregated to provide a solution for each sub-design problem through a design space exploration. In one embodiment of the present invention, the design problem is segregated by the processor. In another embodiment of the present invention, the design problem is segregated by the user.

At step 720, the sub-design-problems are represented in a hierarchal directional graph. The hierarchal directional graph comprises one or more nodes. Moreover, the sub-design problem is represented in the hierarchal directional graph. The sub-design-problems are solved by performing a design space exploration. To perform the design space exploration, a first node from the one or more nodes is selected. Further, the values associated with one or more design parameters at each node are tuned. Furthermore, an input indicative of an instruction is received from a user. Moreover, the values are adjusted based on the input. Furthermore, a simulation on the circuit is performed based on the values adjusted. Further, a second node from the one or more nodes based on the simulation. The design space exploration is performed iteratively.

At step 725, the values from the hierarchal directional graphs are recorded. The values are recorded in a machine learning library. In one embodiment of the present invention, the values are recorded in a database.

At step 730, the design space exploration is performed iteratively, based on the values recorded to obtain optimal design parameters for the circuit.

The process ends at step 735.

Advantageously, embodiments of the present disclosure described herein enables a user to perform design space exploration of a circuit. The system further enables the user to record information during the design space exploration. Further, the system enables the user to visualize the design space exploration as hierarchal directional graphs. Moreover, the system records simulation plans and test benches used by the user during design space exploration. The system further calculates and records interdependencies between one or more design parameters with performance parameters. The system further records history of steps taken by the user during the design space exploration. Moreover, the system provides suggestions to the user during the design space exploration. The system further records an optimal circuit design generated via design space exploration. The system generates proportionality equations between the one or more design parameters and the one or more performance parameters via a machine learning library based on the exploration history. The exploration history is periodically updated. Furthermore, the present disclosure discloses a method of automating the design space exploration.

In the preceding specification, the present disclosure and its advantages have been described with reference to the specific embodiments. However, it will be apparent to a person with ordinary skill in the art that various modifications and changes can be made, without departing from the scope of the present disclosure, as set forth in the claims below. Accordingly, the specification and figures are to be regarded as illustrative examples of the present disclosure, rather than in restrictive sense. All such possible modifications are intended to be included within the scope of present disclosure.

1. A method for performing a design space exploration of a circuit, the method comprising:
receiving, by a processor, a design problem associated with a circuit topology and one or more design parameters of a circuit;
segregating, by the processor, the design problem into two or more sub-design problems, wherein the design problem is segregated to provide a solution for each sub-design problem through a design space exploration;
representing, by the processor, the sub-design-problem in a hierarchal directional graph, wherein the hierarchal directional graph comprises one or more nodes;
recording, by the processor, values from each node in the hierarchal directional graph; and
performing, by the processor, the design space exploration based on the values recorded to obtain an optimal design parameters for the circuit.

2. The method as claimed in claim 1, wherein the one or more nodes comprises a leaf node.

3. The method as claimed in claim 2, wherein the one or more nodes further comprises at least one non-leaf node corresponding to the leaf node.

4. The method as claimed in claim 1, wherein the design space exploration is performed using at least one of a test bench, an evaluation plan, a simulation plan, a performance measurement algorithm, an exploration history and a dependency table, and wherein the exploration history is created during the design space exploration, and wherein the dependency table is provided by a user or generated during the exploration history.

5. The method as claimed in claim 1 wherein the exploration history comprises simulation results, the one or more design parameters, the hierarchal directional graph, and the optimum design parameters.

6. The method as claimed in claim 1, wherein the circuit topology comprises an interconnection of one or more circuit components.

7. The method as claimed in claim 1, wherein the one or more design parameters comprises at least one of length or width or fingers of a transistor, value of resistance, capacitance, inductance, leakage currents, and size of the one or more circuit components.

8. The method as claimed in claim 1, wherein the design space exploration is performed by:
selecting a first node from the one or more nodes;
tuning the values of the one or more design parameters at each node in the one or more nodes;
performing a simulation on the circuit based on values tuned; and
selecting a second node from the one or more nodes based on the simulation results and the exploration history.

9. A system for performing a design space exploration of a circuit, the system comprising:
a processor; and
a memory coupled to the processor, wherein the processor executes program instructions stored in the memory, to:
receive a design problem associated with a circuit topology and one or more design parameters of a circuit;
segregate the design problem into two or more sub-design problems, wherein the design problem is segregated to provide a solution for each sub-design problem through a design space exploration;
represent the sub-design-problem in a hierarchal directional graph, wherein the hierarchal directional graph comprises one or more nodes;
record values from each node in the hierarchal directional graph; and
perform the design space exploration based on the values recorded to obtain an optimal design parameters for the circuit.

10. The system as claimed in claim 9, wherein the one or more nodes comprises at least one leaf node.

11. The system as claimed in claim 10, wherein the one or more nodes further comprises at least one non-leaf node corresponding to the leaf node.

12. The system as claimed in claim 10, wherein the leaf node is at least one of a processing node, a parameter tuning node, and an activity node.

13. The system as claimed in claim 9, wherein the circuit topology comprises an interconnection of one or more circuit components.

14. The system as claimed in claim 9, wherein the one or more design parameters comprises at least one of length or width or fingers of a transistor, value of resistance, capacitance, inductance, leakage currents, and size of the one or more circuit components.

15. The system as claimed in claim 9, wherein the design space exploration is performed by:
selecting a first node from the one or more nodes;
tuning the values of the one or more design parameters at each node in the one or more nodes;
performing a simulation on the circuit based on values tuned; and
selecting a second node from the one or more nodes based on the simulation results and the exploration history.

16. A non-transitory computer readable storage medium comprising program instructions which, when executed, are configured to perform a method for performing a design space exploration of a circuit, the method comprising:
receiving a design problem associated with a circuit topology and one or more design parameters of a circuit;
segregating the design problem into two or more sub-design problems, wherein the design problem is segregated to provide a solution for each sub-design problem through a design space exploration;
representing the sub-design-problem in a hierarchal directional graphs, wherein the hierarchal directional graph comprises one or more nodes;
recording values from each node in the hierarchal directional graph; and
performing the design space exploration based on the values recorded to obtain an optimal design parameters for the circuit.

17. The method as claimed in claim 16, wherein the one or more nodes comprises a leaf node.

18. The method as claimed in claim 17, wherein the one or more nodes further comprises at least one non-leaf node corresponding to the leaf node.

19. The method as claimed in claim 16, wherein the design space exploration is performed using at least one of a test bench, an evaluation plan, a simulation plan, a performance measurement algorithm, an exploration history and a dependency table, and wherein the exploration history is created during the design space exploration, and wherein the dependency table is provided by a user or generated during the exploration history.

20. The method as claimed in claim 16, wherein the design space exploration is performed by:
selecting a first node from the one or more nodes;
tuning the values of the one or more design parameters at each node in the one or more nodes;
performing a simulation on the circuit based on values tuned; and
selecting a second node from the one or more nodes based on the simulation results and the exploration history.
